(19) United States
(12) Patent Application Publication
(10) Pub. No.: US 2020/0147837 A1
(43) Pub. Date: May 14, 2020

(54) METHOD FOR RECYCLING EVA PLASTIC FOAMED MATERIAL

(71) Applicant: Chien-Chuan Kao, Changhua (TW)

(72) Inventor: Chien-Chuan Kao, Changhua (TW)

(73) Assignee: CHA YAU SPONGE ENTERPRISE CO., LTD., CHANGHUA (TW)

(21) Appl. No.: 16/185,958

(22) Filed: Nov. 9, 2018

(51) Int. Cl. B29B 9/06; B29C 43/00; B29C 44/02

(52) U.S. Cl. CPC B29B 9/06; B29K 2023/083; B29C 44/02; B29C 43/003

(57) ABSTRACT

A method for recycling EVA plastic foamed material may include steps of collecting excess plastic foamed compound; granulating through hot melt method; weighing and mixing granular plastic compound; rolling mixed compound into plastic film; and foaming plastic film to produce EVA foam mat. The excess plastic foamed compound can be recycled and reused in the present recycling method, which has environmental benefits and reduces the manufacturing cost. Also, the EVA foam mat, which is formed from the high-quality of the plastic film coupled between two unfoamed plastic mat bodies, has strong structural strength and prolonged lifetime, which prevents the EVA foam mat from deformation due to heavy pressure and protects the floor or tiles thereunder.

### FIELD OF THE INVENTION

The present invention relates to a recycling method and more particularly to a method for recycling EVA plastic foamed material.

### BACKGROUND OF THE INVENTION

The conventional EVA plastic foamed product such as EVA mat usually need to be cut to a designed shape after foaming process, and excess plastic foamed compound always becomes waste and is disposed by incineration. The whole producing process is not only cost-wasted but also not environmental friendly. Additionally, when the EVA excess compound is burn, toxic gas and smoke are produced, which will also harm the environment and human health. Therefore, there remains a need for a new and improved design for a method for recycling EVA plastic foamed material to overcome the problems presented above.

### SUMMARY OF THE INVENTION

The present invention provides a method for recycling EVA plastic foamed material which comprises steps of collecting excess plastic foamed compound; granulating through hot melt method; weighing and mixing granular plastic compound; rolling mixed compound into plastic film; and foaming plastic film to produce EVA foam mat. In the step of collecting excess plastic foamed compound, a plurality of pieces of plastic foamed compounds are respectively cut into a designed shape of a mat piece, and the cut pieces from the plastic foamed compounds are becoming to a plurality of excess plastic compounds which are collected and proceeded in the next step of recycling procedure. The step of granulating through hot melt method is proceeded after the step of collecting excess plastic foamed compound, the excess plastic compounds are melt at a temperature of 200° C. in a hot-melt granulator and the melted excess plastic compounds are extruded and cut into a plurality of granular plastic compounds which are proceeded in the next step of recycling procedure. Sequentially, in the step of weighing and mixing granular plastic compound, the granular plastic compounds are weighed through a scale and arranged in batches with the same designed weight to send into a mixer for the molten process, and each of batches of the granular plastic compounds is configured to be melted and mixed through stirring. The next step is rolling mixed compound into plastic film. Each of the batches of the melted granular plastic compounds is rolled and squeezed out of the mixer to form into a plastic film which has the same weight and thickness. The last step of the method is foaming plastic film to produce EVA foam mat. The plastic film is adapted to couple with a surface of an unfoamed plastic mat body to go through the foaming process, thereby forming an EVA foam mat.

In one embodiment, the temperature of the molten process for the batch of the granular plastic compounds in the mixer is between 80° C. and 90° C.

In another embodiment, the plastic foamed compound is made from EVA, PE, or mixture of EVA and PE.

In still another embodiment, the plastic film is configured to be coupled on a top surface, a bottom surface, or an interlayer of the unfoamed plastic mat body to form into the EVA foam mat under the foaming process.

In a further embodiment, at least one plastic film is coupled between the two unfoamed plastic mat bodies to form into the EVA foam mat under the foaming process.

Comparing with conventional recycling method, the present invention is advantageous because: (i) the excess plastic compounds are configured to be well mixed through the processes of the granulating through hot melt method and the weighing and mixing granular plastic compound, and the plastic films are formed from the well-mixed granular plastic compounds through the step of the rolling mixed compound into plastic film, which increases the density and structural strength of the plastic film; (ii) the EVA foam mat formed from the high-quality of the plastic film coupled between the unfoamed plastic mat bodies has strong structural strength and prolonged lifetime, which prevents the EVA foam mat from deformation due to heavy pressure and protects the floor or tiles thereunder; and (iii) the EVA foam mat formed from the method of the present invention has greater weight, which makes the EVA foam mat not easy to slide after laid on the floor.

### BRIEF DESCRIPTION OF THE DRAWINGS

FIG. 1 is a flow chart of a method for recycling EVA plastic foamed material of the present invention.

FIG. 2 is a top view of excess plastic compounds cut from a piece of plastic foamed compound in the method for recycling EVA plastic foamed material of the present invention.

FIG. 3 is a schematic view of a step of granulating the excess plastic foamed compounds through hot melt method in the method for recycling EVA plastic foamed material of the present invention.

FIG. 4 is a schematic view of a step of weighing and mixing granular plastic compound in the method for recycling EVA plastic foamed material of the present invention.

FIG. 5 is a schematic view of a step of rolling mixed compound into plastic film in the method for recycling EVA plastic foamed material of the present invention.

FIG. 6 is a schematic view of a step of foaming plastic film to produce EVA foam mat in the method for recycling EVA plastic foamed material of the present invention.

FIG. 7 is a three-dimensional view of an EVA mat body made through the method for recycling EVA plastic foamed material of the present invention.

FIG. 8 is a three-dimensional view of the EVA mat body which is cut into a designed shape.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

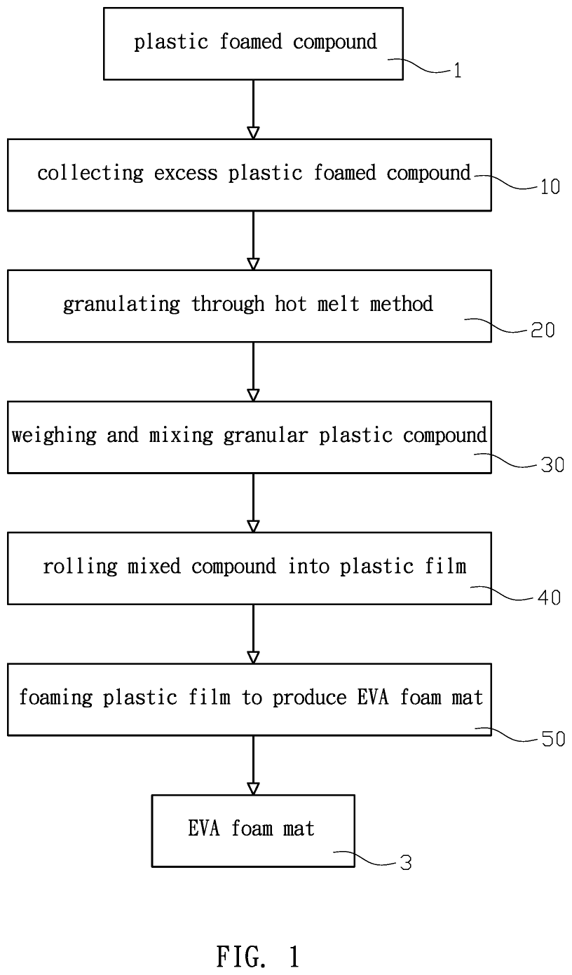

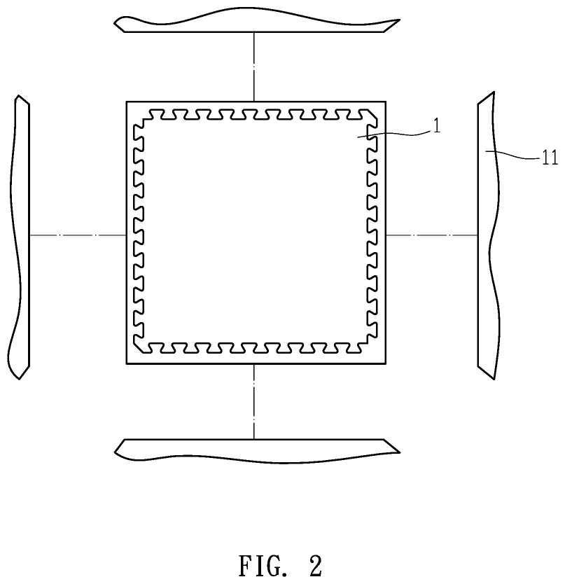

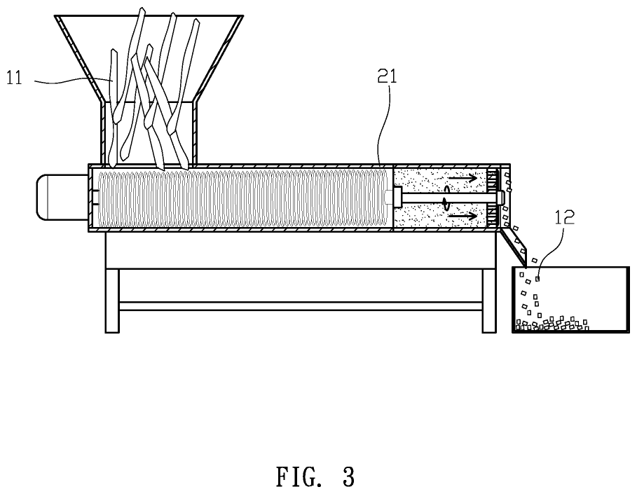

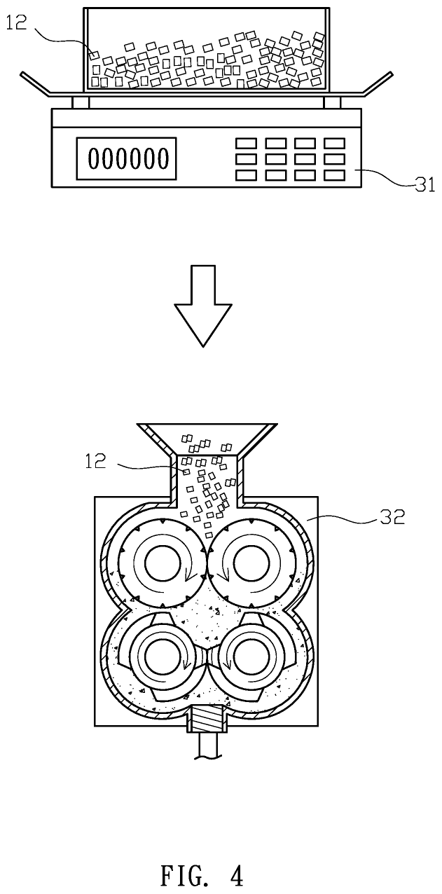

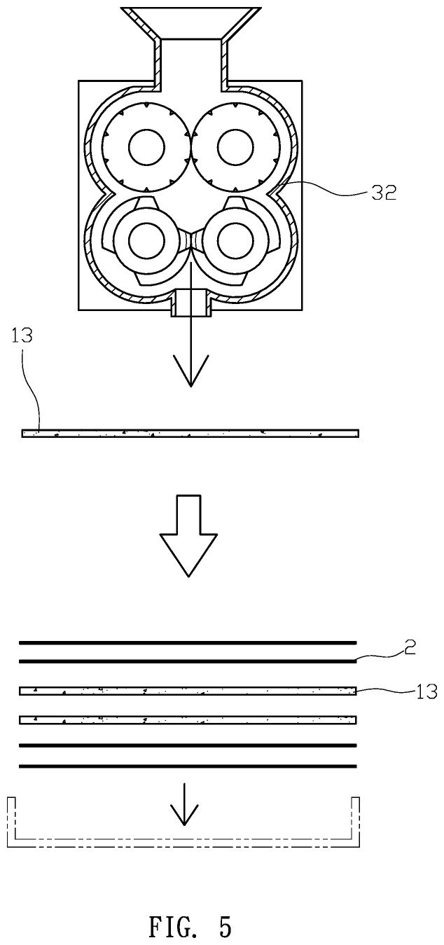

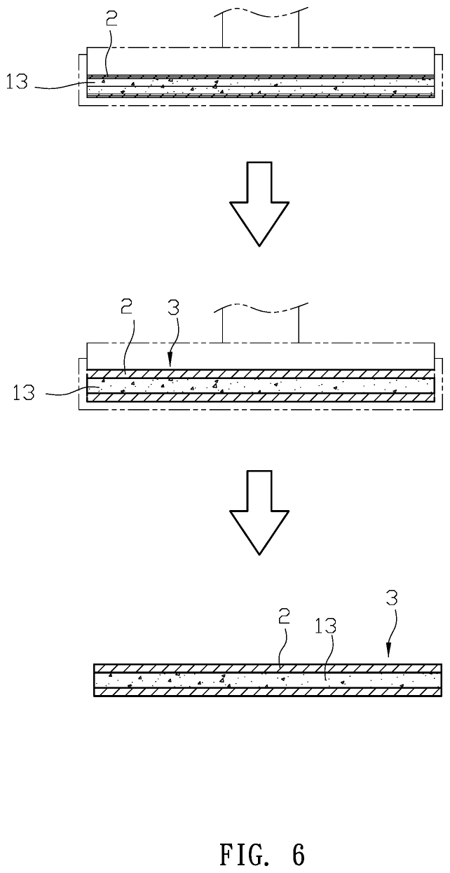

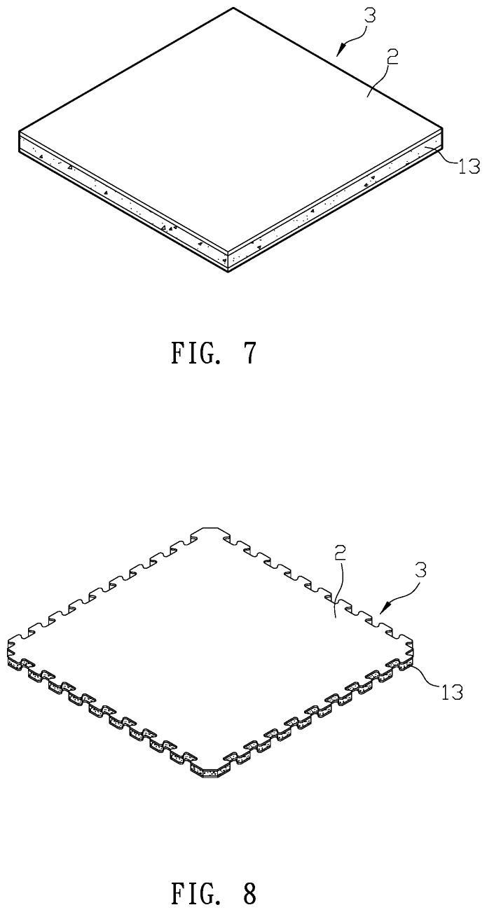

Referring to FIGS. 1 to 6, the present invention provides a method for recycling EVA plastic foamed material which comprises steps of collecting excess plastic foamed compound (10); granulating through hot melt method (20); weighing and mixing granular plastic compound (30); rolling mixed compound into plastic film (40); and foaming plastic film to produce EVA foam mat (50). In the step of collecting excess plastic foamed compound (10), a plurality of pieces of plastic foamed compounds (1) made from EVA, PE or mixture of EVA and PE are respectively cut into a designed shape of a mat piece, and the cut pieces from the plastic foamed compounds (1) are becoming to a plurality of excess plastic compounds (11) which are collected and proceeded in the next step of recycling procedure. The step of granulating through hot melt method (20) is proceeded after the step of collecting excess plastic foamed compound (10), the excess plastic compounds (11) are melt at a temperature of 200° C. in a hot-melt granulator (21) and the melted excess plastic compounds (11) are extruded and cut into a plurality of granular plastic compounds (12) which are sent to the next step of recycling procedure. Sequentially, in the step of weighing and mixing granular plastic compound (30), the granular plastic compounds (12) are weighed through a scale (31) and arranged in batches with the same designed weight to send into a mixer (32) for the molten process in the temperature between 80° C. and 90° C., wherein each of batches of the granular plastic compounds (12) is configured to be melted and mixed through stirring. The next step is rolling mixed compound into plastic film (40). Each of the batches of the melted granular plastic compounds (12) is rolled and squeezed out of the mixer (32) to form into a plastic film (13) which has the same weight and thickness. The last step of the method is foaming plastic film to produce EVA foam mat (50). The plastic film (13) is adapted to couple with a surface of an unfoamed plastic mat body (2) to go through the foaming process, thereby forming an EVA foam mat (3) (as shown in FIGS. 7 and 8).

The plastic film (13) is configured to be coupled on a top surface, a bottom surface, or an interlayer of the unfoamed plastic mat body (2), and at least one plastic film (13) is sandwiched between the two unfoamed plastic mat bodies (2) to form the EVA foam mat (3) under the foaming process.

Comparing with conventional recycling method, the present invention is advantageous because: (i) the excess plastic compounds (11) are configured to be well mixed through the processes of the granulating through hot melt method (20) and the weighing and mixing granular plastic compound (30), and the plastic films (13) are formed from the well-mixed granular plastic compounds (12) through the step of the rolling mixed compound into plastic film (40), which increases the density and structural strength of the plastic film (13); (ii) the EVA foam mat (3) formed from the high-quality of the plastic film (13) coupled between the unfoamed plastic mat bodies (2) has strong structural strength and prolonged lifetime, which prevents the EVA foam mat (3) from deformation due to heavy pressure and protects the floor or tiles thereunder; and (iii) the EVA foam mat (3) formed from the method of the present invention has greater weight, which makes the EVA foam mat (3) not easy to slide after laid on the floor.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A method for recycling EVA plastic foamed material comprising steps of collecting excess plastic foamed compound; a plurality of pieces of plastic foamed compounds respectively cut into a designed shape of a mat piece, and cut pieces from the plastic foamed compounds becoming a plurality of excess plastic compounds which are collected and proceeded in next step;
granulating through hot melt method; the excess plastic compounds melt at a temperature of 200° C. in a hot-melt granulator, and the melted excess plastic compounds extruded and cut into a plurality of granular plastic compounds which are proceeded in next step;
weighing and mixing granular plastic compound; the granular plastic compounds weighed through a scale and arranged in batches with the same designed weight to send into a mixer for the molten process, and each of batches of the granular plastic compounds configured to be melted and mixed through stirring;
rolling mixed compound into plastic film; each of the batches of the melted granular plastic compounds rolled and squeezed out of the mixer to form into a plastic film which has the same weight and thickness; and
foaming plastic film to produce EVA foam mat; the plastic film adapted to couple with a surface of an unfoamed plastic mat body to go through the foaming process, thereby forming an EVA foam mat.

2. The method for recycling EVA plastic foamed material of claim 1, wherein the temperature of the mixer for the molten process is between 80° C. and 90° C.

3. The method for recycling EVA plastic foamed material of claim 1, wherein the plastic foamed compound is made from EVA, PE, or mixture of EVA and PE.

4. The method for recycling EVA plastic foamed material of claim 1, wherein the plastic film is configured to be coupled on a top surface, a bottom surface, or an interlayer of the unfoamed plastic mat body to form into the EVA foam mat under the foaming process.

5. The method for recycling EVA plastic foamed material of claim 1, wherein at least one plastic film is coupled between the two unfoamed plastic mat bodies to form into the EVA foam mat under the foaming process.
